(19) United States
(12) Patent Application Publication
(10) Pub. No.: US 2022/0379894 A1
(43) Pub. Date: Dec. 1, 2022

(54) DRIVING SUPPORT DEVICE, DRIVING SUPPORT METHOD, AND COMPUTER PROGRAM PRODUCT

(71) Applicant: DENSO CORPORATION, Kariya-city (JP)

(72) Inventors: AKIRA ITOH, Kariya-city (JP); NORIKAZU SUGIMOTO, Kariya-city (JP)

(21) Appl. No.: 17/819,202

(22) Filed: Aug. 11, 2022

Related U.S. Application Data
(63) Continuation of application No. PCT/JP2020/047955, filed on Dec. 22, 2020.

(30) Foreign Application Priority Data
Feb. 21, 2020 (JP) 2020-028411

(51) Int. Cl. B60W 30/18; B60W 50/00

(52) U.S. Cl. CPC B60W 30/18163; B60W 50/0097; B60W 2554/80; B60W 2554/404

(57) ABSTRACT

A driving support device includes a prediction unit, a trajectory determination unit, and a necessity determination unit. The prediction unit is configured to predict an increase degree of an inter-vehicle distance between other vehicles in response to the cut-in of the subject vehicle, and determine whether the lane change is permissible based on the increase degree. The necessity determination unit is configured to determine whether a necessity level of the lane change is within an acceptable range. The prediction unit is configured to cancel the determination whether the lane change is permissible based on the increase degree when it is determined that the necessity level is within the acceptable range, and determine whether the lane change is permissible based on a linear prediction of a behavior of the other vehicles.

### CROSS REFERENCE TO RELATED APPLICATION

The present application is a continuation application of International Patent Application No. PCT/JP2020/047955 filed on Dec. 22, 2020, which designated the U.S. and claims the benefit of priority from Japanese Patent Application No. 2020-028411 filed on Feb. 21, 2020. The entire disclosures of all of the above applications are incorporated herein by reference.

### TECHNICAL FIELD

The present disclosure relates to a driving support technique for assisting a lane change of a subject vehicle.

### BACKGROUND

A device for controlling a lane change of a subject vehicle is known. This device is configured to determine that the lane change is allowable when the inter-vehicle distance between vehicles traveling in the lane to which the subject vehicle is entering is at or above a threshold value, and then changes lanes.

### SUMMARY

A first aspect of the present disclosure is a driving support device configured to assist a lane change of a subject vehicle that cuts in a line of other vehicles traveling in a destination lane. The driving support device includes: a prediction unit configured to predict an increase degree of an inter-vehicle distance between the other vehicles in response to the cut-in of the subject vehicle, and determine whether the lane change is permissible based on the increase degree; a trajectory determination unit configured to determine, as a traveling trajectory of the subject vehicle, a lane change trajectory along which the subject vehicle changes lanes when it is determined that the lane change is permissible, and determine, as the traveling trajectory of the subject vehicle, a cancel trajectory along which the subject vehicle cancels the lane change when it is determined that the lane change is not permissible; and a necessity determination unit configured to determine whether a necessity level of the lane change is within an acceptable range. The prediction unit is configured to cancel the determination whether the lane change is permissible based on the increase degree when it is determined that the necessity level is within the acceptable range, and determine whether the lane change is permissible based on a linear prediction of a behavior of the other vehicles.

A second aspect of the present disclosure is a method for a processor to assist a lane change of a subject vehicle that cuts in a line of other vehicles traveling in a destination lane. The method includes: predicting an increase degree of an inter-vehicle distance between the other vehicles in response to the cut-in of the subject vehicle; determining whether the lane change is permissible based on the increase degree; determining, as a traveling trajectory of the subject vehicle, a lane change trajectory along which the subject vehicle changes lanes when it is determined that the lane change is permissible; determining, as the traveling trajectory of the subject vehicle, a cancel trajectory along which the subject vehicle cancels the lane change when it is determined that the lane change is not permissible; and determining whether a necessity level of the lane change is within an acceptable range. The determination whether the lane change is permissible based on the increase degree is canceled and it is determined whether the lane change is permissible based on a linear prediction of a behavior of the other vehicles when it is determined that the necessity level is within the acceptable range.

A third aspect of the present disclosure is a computer program product for assisting a lane change of a subject vehicle that cuts in a line of other vehicles traveling in a destination lane, the computer program product being stored on at least one non-transitory computer readable medium and comprising instruction configured to, when executed by at least one processor, cause the at least one processor to: predict an increase degree of an inter-vehicle distance between the other vehicles in response to the cut-in of the subject vehicle; determine whether the lane change is permissible based on the increase degree; determine, as a traveling trajectory of the subject vehicle, a lane change trajectory along which the subject vehicle changes lanes when it is determined that the lane change is permissible; determine, as the traveling trajectory of the subject vehicle, a cancel trajectory along which the subject vehicle cancels the lane change when it is determined that the lane change is not permissible; determine whether a necessity level of the lane change is within an acceptable range; cancel the determination whether the lane change is permissible based on the increase degree and determine whether the lane change is permissible based on a linear prediction of a behavior of the other vehicles when it is determined that the necessity level is within the acceptable range.

### BRIEF DESCRIPTION OF THE DRAWINGS

FIG. 1 is a diagram illustrating a system including a driving support device.

FIG. 2 is a block diagram illustrating an example of functions of the driving support device.

FIG. 3 is a graph illustrating a difference in a inter-vehicle distance changing with time according to an aggressive level.

FIG. 4 is a graph illustrating a difference in a speed changing with time according to an aggressive level.

FIG. 5 is a diagram for explaining an example of a method of predicting an increase degree.

FIG. 6 is a diagram for explaining an example of a method of predicting an increase degree.

FIG. 7 is a flowchart illustrating the driving support method performed by the driving support device.

FIG. 8 is a flowchart illustrating details of a permission determination process.

### EMBODIMENTS

### Comparative Example

A device of a comparative example does not determine that the lane change is permissible when the inter-vehicle distance between the other vehicles is not at or above the threshold value before the lane change. Accordingly, the device may not perform the lane change when the inter-vehicle distance between the other vehicles is relatively short.

### First Embodiment

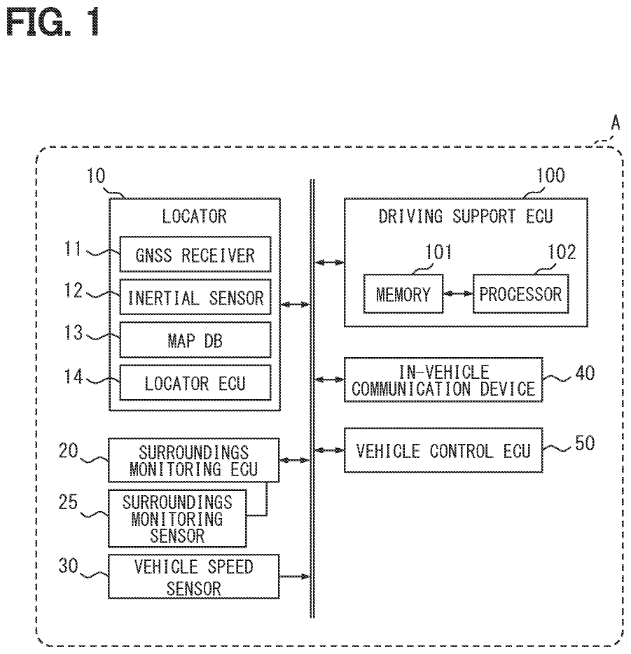

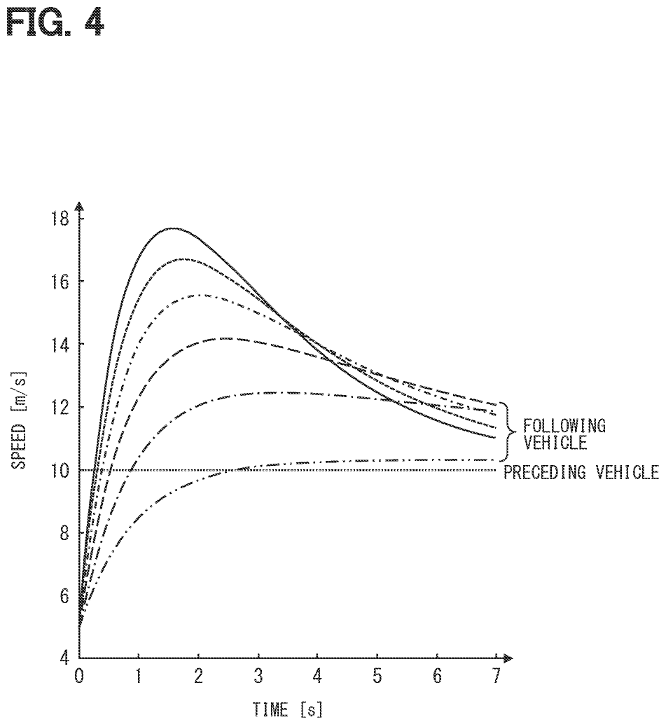

A driving support device according to a first embodiment will be described with reference to FIGS. 1 to 8. The driving assistance device of the first embodiment is provided by a driving support ECU which is an electronic control device mounted on a subject vehicle A. The vehicle A has at least one of an automatic driving function and an advanced driving assistance function. The driving assistance ECU 100 predicts the behavior of a moving object around the subject vehicle A, and assists traveling of the subject vehicle A based on result of the prediction. The driving support ECU 100 is, as shown in FIG. 1, connected to a locator 10, a surroundings monitoring ECU 20, a vehicle speed sensor 30, an in-vehicle communication device 40, and a vehicle control ECU 50 via a communication bus or the like.

The locator 10 generates location information of the subject vehicle A by a complex positioning method that combines multiple types and pieces of acquired information. The locator 10 includes a GNSS (Global Navigation Satellite System) receiver 11, an inertial sensor 12, and a map database (hereinafter, map DB) 13, and a locator ECU 14. The GNSS receiver 11 receives positioning signals from multiple positioning satellites. The inertial sensor 12 is a sensor that detects the inertial force acting on the subject vehicle A. The inertial sensor 12 includes, for example, a 3-axis gyro sensor and a 3-axis acceleration sensor, and detects an angular velocity and an acceleration acting on the subject vehicle A.

The map DB 13 is a nonvolatile memory, and stores map information such as link data, node data, terrain, structure and the like. The map information is, for example, a three-dimensional map consisting of a point cloud of feature points of the terrain and the structure. The three-dimensional map may be generated based on a captured image by REM (Road Experience Management). The map information may include road sign information, traffic regulation information, road construction information, weather information, and the like. The map information stored in the map DB 13 updates regularly or at any time based on the latest information received by the in-vehicle communication device 40.

The locator ECU 14 mainly includes a microcomputer equipped with a processor, a memory, an input/output interface, and a bus connecting these elements. The locator ECU 14 combines the positioning signals received by the GNSS receiver 11, the map data of the map DB 13, and the measurement results of the inertial sensors 12 to sequentially detect the vehicle position (hereinafter, subject vehicle position) of the subject vehicle A. The vehicle position may consist of, for example, coordinates of latitude and longitude. The vehicle position may be measured using a travel distance obtained from signals sequentially output from the vehicle speed sensor 30 mounted on the subject vehicle A. When a three-dimensional map provided by a road shape and a point group of feature points of a structure is used as map data, the locator ECU 14 may specify the position of the own vehicle by using the three-dimensional map and the detection results of the surroundings monitoring sensor 25 without using the GNSS receiver 11. The locator ECU 14 sequentially provides the vehicle position information, the acceleration information of the subject vehicle A, map information around the subject vehicle A, and the like to the driving support ECU 100.

The surroundings monitoring ECU 20 is mainly configured of a microcomputer including a processor, a memory, an input/output interface, and a bus connecting these elements, and executing various control programs stored in the memory to perform various processes. The surroundings monitoring ECU 20 acquires detection result from the surroundings monitoring sensor 25, and recognizes the traveling environment of the subject vehicle based on the detection result.

The surroundings monitoring sensor 25 is an autonomous sensor that monitors environment around the subject vehicle A, and includes a LiDAR (Light Detection and Ranging/Laser Imaging Detection and Ranging), which detects a point cloud of feature points of object on land, and a periphery monitoring camera, which captures images of a predetermined area including the front of the subject vehicle A. The surroundings monitoring sensor 25 may include a millimeter wave radar, sonar, and the like.

The surroundings monitoring ECU 20 can, for example, analyze and process point group images acquired from the LiDAR and images acquired from periphery monitoring cameras, etc., to recognize the presence or absence of obstacles on route of travel of the subject vehicle A and moving object around the subject vehicle A as well as the position, direction of travel, and etc. The surroundings monitoring ECU 20 sequentially provides the above information about other vehicles as other vehicle information to the driving support ECU 100.

The in-vehicle communication device 40 is a communication module mounted on the subject vehicle A. The in-vehicle communication device 40 has at least a V2N (Vehicle to cellular Network) communication function in line with communication standards such as LTE (Long Term Evolution) and 5G, and sends and receives radio waves to and from base stations around the subject vehicle A. The in-vehicle communication device 40 may further have functions such as road-to-vehicle (Vehicle to roadside Infrastructure, hereinafter “V2I”) communication and inter-vehicle (Vehicle to Vehicle, hereinafter “V2V”) communication. The in-vehicle communication device 40 may acquire the other vehicle information by V2V communication and provide it to the driving support ECU 100. The in-vehicle communication device 40 enables cooperation between a cloud and in-vehicle system (Cloud to Car) by V2N communication. By installing the in-vehicle communication device 40, the subject vehicle A is able to connect to the Internet.

The vehicle control ECU 50 is an electronic control device that performs acceleration and deceleration control and steering control of the subject vehicle A. The vehicle control ECU 50 includes a steering ECU that performs steering control, a power unit control ECU and a brake ECU that perform acceleration/deceleration control, and the like. The vehicle control ECU 50 acquires detection signals output from respective sensors such as the steering angle sensor, the vehicle speed sensor 30, and the like mounted on the subject vehicle, and outputs a control signal to an electronic control throttle, a brake actuator, an EPS (Electronic Power Steering) motor, and the like. The vehicle control ECU 50 controls each travel control device so as to realize automatic driving or advanced driving assistance according to each plan according to a track plan described later from the driving support ECU 100.

The driving support ECU 100 assists the lane change of the subject vehicle A based on the information described above. The driving support ECU 100 mainly includes a memory 101, a processor 102, an input/output interface, a bus connecting these components, and the like. The processor 102 is a hardware for arithmetic processing. The processor 102 includes, as a core, at least one type of, for example, a CPU (Central Processing Unit), a GPU (Graphics Processing Unit), an RISC (Reduced Instruction Set Computer) CPU, and so on.

The memory 101 is at least one type of non-transitory tangible storage medium, such as a semiconductor memory, a magnetic storage medium, and an optical storage medium, for non-transitory storing or memorizing computer readable programs and data. The memory 101 stores various programs executed by the processor 102, such as a travel assistance program described later.

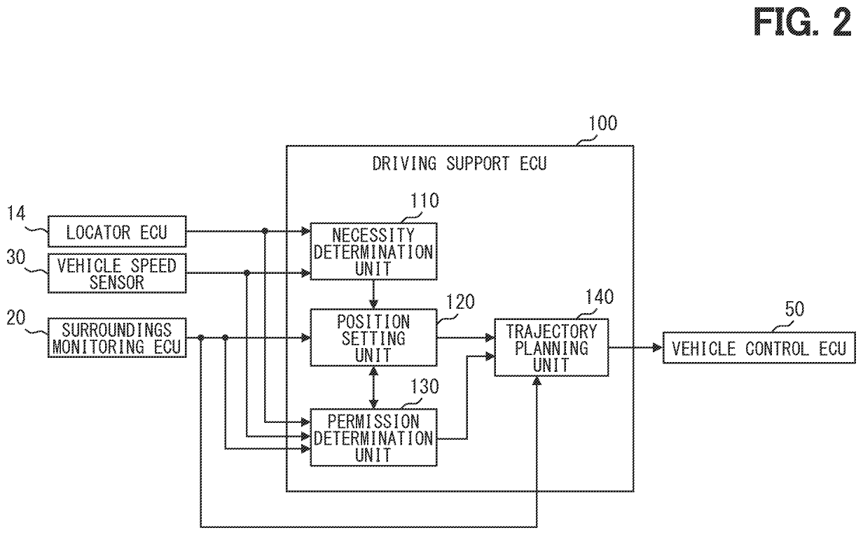

The processor 102 executes a plurality of instructions included in the driving support program stored in the memory 101. As a result, the driving support ECU 100 builds functional units for assisting the lane change of the subject vehicle A to let the subject vehicle A to cut in the lane in which other vehicles are traveling. As described above, in the driving support ECU 100, the program stored in the memory 101 causes the processor 102 to execute a plurality of instructions, thereby constructing a plurality of functional units. Specifically, the driving support ECU 100 builds, as shown in FIG. 2, a necessity determination unit 110, a position setting unit 120, a permission determination unit 130, and a trajectory plan unit 140, and the like.

The necessity determination unit 100 is configured to determine a necessity of the lane change. Specifically, the necessity determination unit 110 is configured to determine whether the lane change is necessary in the current scene based on a traveling route the destination, map information around the subject vehicle A, the other vehicle information around the subject vehicle A, and the like.

For example, the necessity determination unit 110 is configured to determine that the lane change is necessary in a scene where the destination is unreachable along the current lane or the current lane is a detour to reach the destination (difficult-to-reach scene). The difficult-to-reach scene includes: a scene where the subject vehicle A is traveling in a lane other than a right-turn lane in a situation where a right-turn is required at an intersection; a scene where the subject vehicle A is traveling in a lane of a forked road heading in a different direction from the destination; a scene where the subject vehicle A is traveling in a lane that is not adjacent to the exit lane when exiting the highway; and the like. In addition, the necessity determination unit 110 determines that the lane change is necessary in a scene where the subject vehicle A is traveling in a merging lane in a merging scene. Further, the necessity determination unit 110 determines that the lane change is necessary in a restricted scene where the continuous traveling in the current lane is restricted due to construction work, a traffic accident, the presence of an obstacle, or the like. The necessity determination unit 110 determines that the lane change is necessary in an overtaking scene where another vehicle is traveling at a low speed in the current lane in front of the subject vehicle A.

Further, when the necessity determination unit 110 determines that the lane change is necessary, the necessity determination unit 110 determines whether the necessity level of the lane change is within an acceptable range. Specifically, the necessity determination unit 110 determines that the necessity level of the lane change is outside the acceptable range when the type of the current scene is any one of the difficult-to-reach scene, the merging scene, and the restricted scene. In contrast, the necessity determination unit 110 determines that the necessity level is within the acceptable range when the current scene is the overtaking scene. That is, the necessity determination unit 110 determines that the necessity level is outside the acceptable range when it is difficult to arrive at the destination without the lane change and when it is difficult to continue to travel without the lane change. The necessity determination unit 110 sequentially provides the determination results of the necessity of the lane change and the determination results of the necessity level when it is determined that the lane change is necessary. The necessity determination unit 110 is an example of a necessity level determination unit.

The position setting unit 120 is configured to set a prediction start position for an increase degree of a separation distance between other vehicles. Specifically, the position setting unit 120 acquires the other vehicle information about the vehicles traveling in the lane which is the destination of the lane change (destination lane), and determines the other vehicle that is to be a preceding vehicle ahead of the subject vehicle A and the other vehicle that is to be a following vehicle behind the subject vehicle A after the lane change. That is, the position setting unit 120 determines a space which the subject vehicle A enters by the lane change. The position setting unit 120 may determine two vehicles, which have the largest inter-vehicle distance in the detection range of the surroundings monitoring sensor 25, as the preceding vehicle and the following vehicle after the lane change.

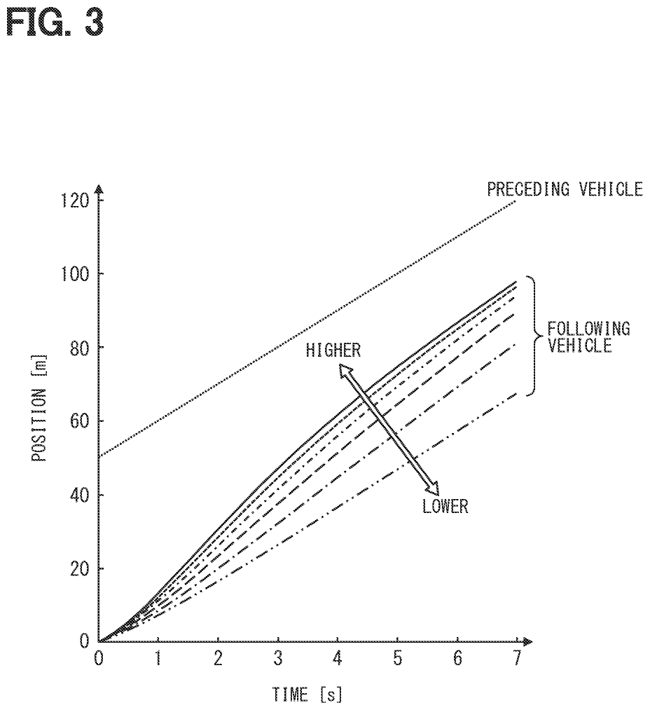

The position setting unit 120 is configured to estimate an aggressive level a of the determined following vehicle. The aggressive level a is an index indicating behavior characteristics of the other vehicle reacting to changes of the inter-vehicle distance. Specifically, the aggressive level a relates to behavior characteristics of approaching the actual inter-vehicle distance to the target inter-vehicle distance when the actual inter-vehicle distance is different from an inter-vehicle distance which is assumed that the other vehicle sets as the target inter-vehicle distance. When the target inter-vehicle distance is greater than the actual inter-vehicle distance, the greater the aggressive level a of the vehicle is, the more rapidly the vehicle decreases the inter-vehicle distance as shown in FIG. 3. Further, the greater the aggressive level a of the vehicle is, the more rapidly the vehicle accelerates to a higher speed and then decreases the speed.

The position setting unit 120 is configured to calculate the aggressive level a using a trained model which was tuned by machine learning. The trained model may be generated using, for example, supervised learning with dataset containing (i) a rate of change in the position and the speed of the following vehicle, which is input data, and (ii) the aggressive level a, which is output data. When the position setting unit 120 determines the following vehicle, the position setting unit 120 observes the position of the following vehicle (following vehicle position xi) and the speed of the following vehicle (following vehicle speed vi) for a predetermined time (a few seconds, for example) to acquire the input data. The position setting unit 120 is configured to provide, to the permission determination unit 130, the other vehicle information of the preceding vehicle and the following vehicle and the estimated aggressive level a. In addition, the position setting unit 120 is configured to cause the trajectory plan unit 140 to generate a preparation trajectory along which the vehicle is to go ahead of the following vehicle in the current lane to prepare the lane change.

The permission determination unit 130 is configured to predict the increase degree of the inter-vehicle distance between the preceding vehicle and the following vehicle determined by the position setting unit 120 in response to the cut-in of the subject vehicle A, and determine whether the lane change is permitted. The permission determination unit 130 is configured to predict the increase degree based on a spring model in which the preceding vehicle and the following vehicle are mass points. Specifically, the permission determination unit 130 is configured to predict a negative acceleration (deceleration) of the following vehicle in response to the cut-in of the subject vehicle A based on the spring model, and then predict the increase degree based on the deceleration. The deceleration in response to the cut-in of the subject vehicle A is a deceleration expected when the following vehicle is to yield to the cut-in vehicle A to keep a distance from the subject vehicle A. Hereinafter, the deceleration may be referred to as an expected deceleration.

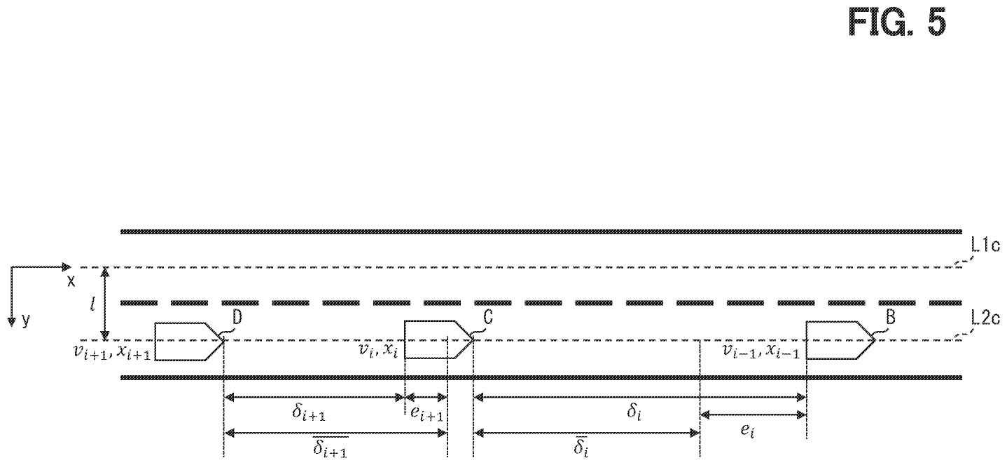

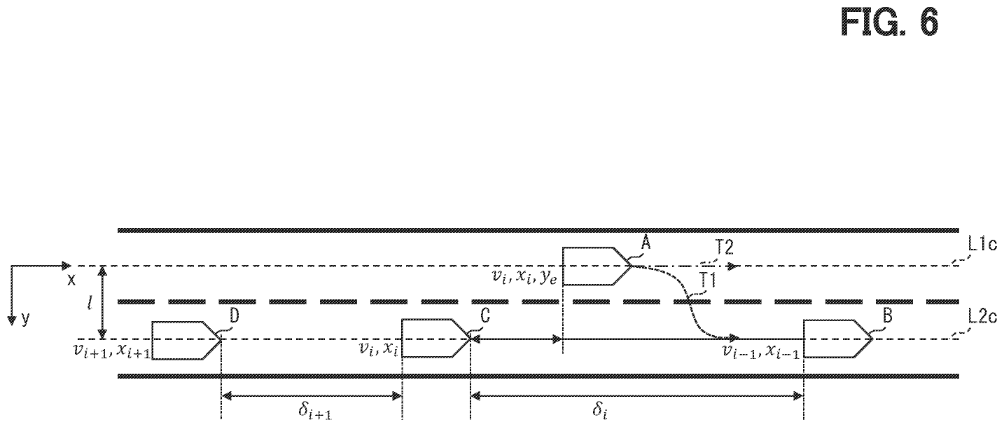

An example of a method of calculating the expected deceleration will be described below with reference to FIGS. 5, 6. In this example, the other vehicles B, C, D are traveling in the destination lane, where the speed of the other vehicle B is vi−1, the position of the other vehicle B is xi−1, the speed of the other vehicle C is vi, the position of the other vehicle C is xi, the speed of the other vehicle D is vi+1, the position of the other vehicle D is xi+1. The positions xi−1, xi, xi+1 are the position in a direction of the current lane. The actual inter-vehicle distance between the other vehicles B, C is δi. In this situation, an ideal value of the inter-vehicle distance (target inter-vehicle distance value) δi between the other vehicles B, C is represented by the following formula (1), where ‘h’ is an inter-vehicle time, and δmin is a minimum inter-vehicle distance. In the formula (1), the target inter-vehicle distance value δi is a symbol δi with an overline .

δ̅ᵢ=hvᵢ+δₘᵢₙ (Formula 1)

The inter-vehicle time h and the minimum inter-vehicle distance δmin are design parameters based on the results of actual vehicle tests or simulations. From the formula (1), the deviation ei of the actual inter-vehicle distance δi with respect to the target inter-vehicle distance value δi is expressed by the following formula (2).

eᵢ=hvᵢ+δₘᵢₙ−δᵢ (Formula 2)

It is assumed that the other vehicle C, through acceleration/deceleration control, brings the current actual inter-vehicle distance bi closer to the target inter-vehicle distance value δi which is the ideal inter-vehicle distance, that is, brings the deviation ei closer to 0. Based on the behavior of the spring model, the following relationship in the following formula (3) can be seen to hold, using deviation ei and aggressive level a.

ėₗ+aeᵢ=0 (Formula 3)

Here, the relationship of the following formula (4) is established from the formula (2) and the formula (3), where ui is the acceleration of the other vehicle C that brings the deviation ei to 0.

$${u}_{i} = \frac{{v}_{i - 1} - {v}_{i} - a ( {hv}_{i} + {δ}_{min} - {δ}_{i} )}{h} \qquad ( Formula 4 )$$

As shown in FIG. 6, when the subject vehicle A cuts in front of the other vehicle C, the other vehicle C recognizes the subject vehicle A as a new preceding vehicle after the start of the lane change. In this case, it can be assumed that the other vehicle C generates the acceleration ui such that the actual inter-vehicle distance δi between the subject vehicle A, which is the new preceding vehicle, and the other vehicle C approaches to the target inter-vehicle distance value δi . The acceleration ui in a decelerating direction, that is, a negative value of the acceleration ui is the expected deceleration of the other vehicle C. As a result, the expected deceleration can be calculated based on the formula (4) and the following formula (5). ‘vi−1’ in the formula (4) can be replaced with the speed ve of the subject vehicle A.

δᵢ=xₑ−xᵢ (Formula 5)

The timing when the other vehicle C recognizes the subject vehicle A as the new preceding vehicle may be a timing when ye>l/2 and x e≥xi, for example. ‘ye’ is a distance in the lateral direction (vehicle width direction) from a center line L1c of the current lane to the subject vehicle A, and ‘l’ is a distance from the center line L1c to a center line L2c of the destination lane. The permission determination unit 130 is configured to acquire the subject vehicle position xe from the locator ECU 14, the subject vehicle speed ve from the vehicle speed sensor 30, and the following vehicle position xi and the following vehicle speed vi from the surroundings monitoring ECU 20. The permission determination unit 130 may be configured to acquire the following vehicle position xi and the following vehicle speed vi by vehicle-to-vehicle communication.

The permission determination unit 130 is configured to predict the increase degree due to the yielding behavior of the following vehicle in response cut-in of the subject vehicle A, based on the calculated expected deceleration. The permission determination unit 130 is configured to determine whether or not to permit the lane change based on the predicted increase degree. For example, the permission determination unit 130 determines that the lane change is permissible when a situation where the subject vehicle A can cut in from of the following vehicle without colliding with the following vehicle continues for a predetermined time. When the situation where the subject vehicle A can cut in without colliding does not continue for the predetermined time, the permission determination unit 130 determines that the lane change is not permissible. The permission determination unit 130 starts the above determination process when the subject vehicle A reaches the front of the following vehicle, for example. The permission determination unit 130 is configured to repeatedly perform the above determination process until the lane change is completed.

The permission determination unit 130 is configured to calculate parameters required for generating a lane change trajectory (hereinafter, referred to as LC trajectory) T1 for the lane change based on the expected deceleration. Specifically, the permission determination unit 130 calculates, as determination variables, parameters including the start position of the lane change, the speed at the start of the lane change, and the time length from the start to the end of the lane change (completion time length), by solving an optimization problem. For example, the permission determination unit 130 assumes the LC trajectory T1 to be a fifth-order polynomial, for example, and searches for the parameters that minimize the jerk (dynamicity) of the subject vehicle A and the following vehicle in the lane change. The permission determination unit 130 provides the calculated parameters to the trajectory plan unit 140.

The permission determination unit 130 is configured to cancel the prediction of the other vehicle behavior based on the increase degree when the necessity determination unit 110 determines that the necessity level of the lane change is within the acceptable range. In this case, the permission determination unit 130 is configured to determine whether the lane change is permissible based on a linear prediction. Specifically, the permission determination unit 130 calculates the inter-vehicle distance at the start of the lane change in an assumption that the current speeds of the other vehicles are maintained, based on the speeds and the positions of the preceding vehicle and the following vehicle. The permission determination unit 130 determines that the lane change is permissible when the calculated inter-vehicle distance is above the threshold value. The permission determination unit 130 determines that the lane change is not permissible when the inter-vehicle distance is below the threshold value. Alternatively, the permission determination unit 130 may be configured to calculate, instead of the inter-vehicle distance, a time before the other vehicle collides with the subject vehicle A, and determine whether the lane change is permissible based on the time. The permission determination unit 130 is configured to sequentially provide, to the trajectory plan unit 140, the determination result of the permission based on the expected deceleration or the linear prediction. The permission determination unit 130 is an example of a prediction unit.

The trajectory plan unit 140 is configured to determine a traveling trajectory of the subject vehicle A. For example, the trajectory plan unit 140 is configured to generate the preparation trajectory along which the subject vehicle A moves to a side of the space in the destination lane to prepare for the lane change, based on the information acquired from the position setting unit 120. When the permission determination unit 130 determines that the lane change is permissible, the trajectory plan unit 140 generates the LC trajectory from the start position to the end position of the lane change. The trajectory plan unit 140 fixes the LC trajectory T1 using the start position, the start speed, and the completion time of the lane change calculated by the permission determination unit 130.

When the permission determination unit 130 determines that the lane change is not permissible, the trajectory plan unit 140 generates the cancel trajectory T2 along which the subject vehicle A stop changing lanes. As shown in FIG. 6, the cancel trajectory T2 is a trajectory along which the subject vehicle A continues traveling in the current traveling lane. The trajectory plan unit 140 may be configured to generate both the LC trajectory T1 and the cancel trajectory T2 before the determination, and determine which one to use based on the determination result. The trajectory plan unit 140 sequentially provides the generated trajectory T1, T2 to the vehicle control ECU 50. The trajectory plan unit 140 is an example of a trajectory determination unit.

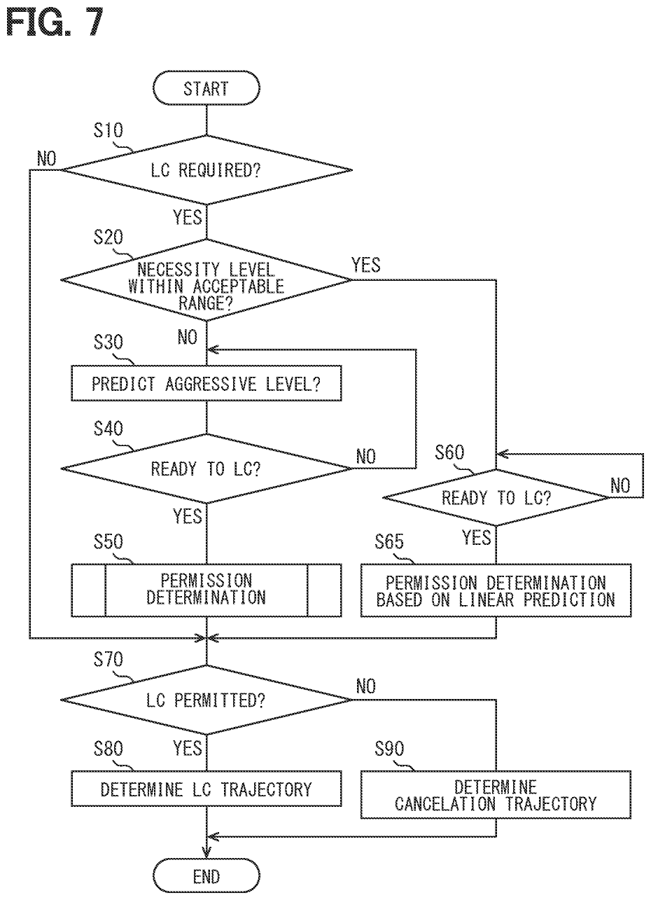

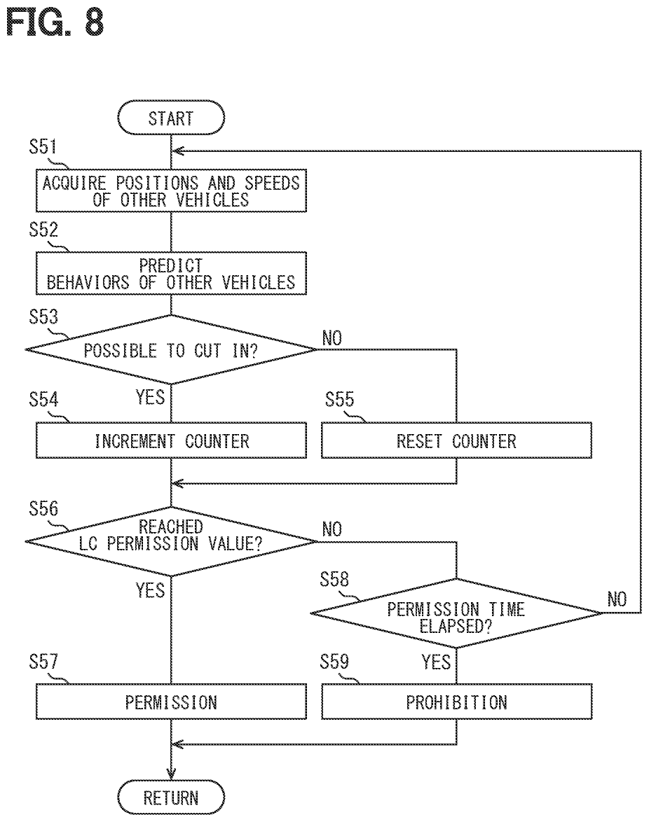

Next, the flow of the travel assistance method realized by the driving support ECU 100 executing the travel assistance program will be described below with reference to FIGS. 7, 8. In FIGS. 7, 8, the lane change is referred to as “LC”. In a flowchart to be described later, “S” means multiple steps of the flowchart to be executed by multiple instructions included in the travel assistance program.

In S10 of FIG. 7, the necessity determination unit 100 determines the necessity of the lane change. When it is determined that the lane change is not necessary, the process ends. When it is determined that the lane change is necessary, the process proceeds to S20. In S20, the necessity determination unit 110 determines whether the necessity level of the lane change is within the acceptable range. When it is determined that the necessity level is outside the acceptable range, the flow proceeds to S30.

In S30, the position setting unit 120 determines the preceding vehicle and the following vehicle, and calculates the aggressive level a of the following vehicle. Next, in S40, the position setting unit 120 fixes the prediction start position for the behavior of the other vehicles, and prepares for the lane change. When the prediction start position is not fixed in S40, the flow returns to S30 to determine the preceding vehicle and the following vehicle again.

When the lane change is prepared in S40, the permission determination unit 130 performs the determination in S50 in consideration of the yielding behavior of the following vehicle. That is, the permission determination unit predicts the increase degree of the inter-vehicle distance between the preceding vehicle and the following vehicle in response to the cut-in of the subject vehicle A, and determines whether the lane change is permissible based on the prediction results.

The details of S50 executed by the permission determination unit 130 will be described with reference to FIG. 8. In S51, the positions and the speeds of the preceding vehicle and the following vehicle are acquired. Next, in S52, the behavior of the following vehicle is simulated. Specifically, the increase degree of the inter-vehicle distance in response to the cut-in of the subject vehicle A is calculated based on the estimation of the expected deceleration. In S53, it is determined whether the cut-in is permissible based on the simulation results. Specifically, in S53, when it is determined that the following vehicle will not collide with the subject vehicle A, it is determined that the cut-in is permissible. In contrast, when it is determined that the following vehicle would collide with the subject vehicle A, it is determined that the cut-in is not permissible.

When it is determined in S53 that the cut-in is permissible, a counter is incremented in S54. In contrast, when it is determined in S53 that the cut-in is not permissible, a counter is cleared in S55. In S56 subsequent to S54 or S55, it is determined whether the number of the counter reached a permission value (LC permission value) for the lane change. When it is determined that the counter reached the permission value, the determination that the lane change is permissible is fixed in S57.

In contrast, when it is determined in S56 that the counter has not reached the permission value, it is determined in S58 whether the acceptable time has elapsed after the count is started. If it is determined that the acceptable time has not elapsed, the process returns to S51. In contrast, when it is determined that the acceptable time has elapsed, the determination that the lane change is not permissible is fixed in S59. After the execution of S57 or S59, the flow proceeds to S70 of FIG. 7.

When it is determined in S20 that the necessity level of the lane change is inside the acceptable range, the flow proceeds to S60. In S60, the position setting unit 120 fixes the prediction start position for the behavior of the other vehicles, and prepares for the lane change, as in S40. When the prediction start position is not fixed in S60, the preceding vehicle and the following vehicle are determined again to prepare for the lane change again. When the lane change is prepared in S60, the permission determination unit 130 determines in S65 whether the lane change is permissible based on the linear prediction for the behavior of the other vehicles.

In S70 subsequent to S50 or S65, the trajectory plan unit 140 determines whether the lane change is permitted. When it is determined that the lane change is permitted, the trajectory plan unit 140 determines in S80 the LC trajectory T1 as the traveling trajectory. As a result of S80, the lane change is started when the lane change is not started, and the lane change is continued when the lane change is in progress.

In contrast, when it is determined that the lane change is not permitted, the trajectory plan unit 140 determines in S90 the cancel trajectory T2 as the traveling trajectory. As a result of 90, the traveling in the current lane is continued when the lane change is not started, and the subject vehicle A returns to the original lane when the lane change is in progress.

The above-mentioned S20 is an example of an “necessity level determination process”, S50 is an example of a “prediction process”, and S80, S90 are an example of a “trajectory determination process”.

The description below explains operations and effects provided by the first embodiment.

According to the first embodiment, the increase degree of the inter-vehicle distance between the other vehicles B, C in response to the cut-in of the subject vehicle A is predicted, and then the lane change is executed or canceled. Accordingly, the lane change is likely to be permitted even when the inter-vehicle distance before the lane change is started is relatively small. Accordingly, the lane change is likely to be executed.

According to the first embodiment, the increase degree is predicted based on the spring model in which the other vehicle is assumed as the mass point. Accordingly, the interaction between the behavior of the other vehicles is simulated to reflect it to the determination.

Further, according to the first embodiment, the expected deceleration of the other vehicle C in response to the cut-in which is to be the following vehicle after the lane change is estimated, and the increase degree is predicted based on the expected deceleration. Accordingly, the permission determination reflects how much the following vehicle decelerates in response to the lane change of the subject vehicle A.

Further, according to the first embodiment, since the expected deceleration is estimated based on the behavior characteristics of the other vehicle C in response to the change in the inter-vehicle distance, the behavior of the other vehicle can be accurately predicted. According to the first embodiment, since the start timing of the lane change after the subject vehicle A reaches the front of the other vehicle C is determined based on the increase degree, the lane change can be started with improved accuracy.

Further, according to the first embodiment, the necessity level of the lane change is determined, and the determination whether the lane change is permissible based on the increase degree is canceled when it is determined that the necessity level is within the acceptable range. Accordingly, the different determination criterions can be used for the situation in which the necessity level is high and the situation in which the necessity level is low. Especially in the first embodiment, since the determination is executed without considering the increase degree in response to the cut-in, the lane change can be performed with longer inter-vehicle distance when the necessity level is low.

### Other Embodiments

The disclosure in the present specification is not limited to the illustrated embodiments. The disclosure encompasses the illustrated embodiments and variations based on the embodiments by those skilled in the art. For example, the present disclosure is not limited to the combinations of components and/or elements shown in the embodiments. The present disclosure may be implemented in various combinations. The present disclosure may have additional members which may be added to the embodiments. The present disclosure encompasses the embodiments where some components and/or elements are omitted. The present disclosure encompasses replacement or combination of components and/or elements between one embodiment and another. The disclosed technical scope is not limited to the description of the embodiment. Several technical scopes disclosed are indicated by descriptions in the claims and should be understood to include all modifications within the meaning and scope equivalent to the descriptions in the claims.

In the above-described embodiment, the necessity determination unit 110 is configured to determine whether the necessity level is within the acceptable range based on the traveling scene. Alternatively, the necessity determination unit may determine whether the necessity level is within the acceptable range based on the distance from the subject vehicle A to a specific point. In this case, the necessity determination unit 110 may be configured to determine that the necessity level is within the acceptable range when the distance to the specific point is above a threshold distance, and determine that the necessity level is outside the acceptable range when the distance is below the threshold distance. The specific point may be a point where the lane change is no longer available after the subject vehicle A passes the specific point. Specifically, the specific point may be a right-turn point in a scene where the subject vehicle needs to change lanes into a right-turn lane, a branch position in a scene where the subject vehicle is on a forked road, or an end position of a merging lane in a scene where the subject vehicle A is traveling in the merging lane.

The travel assistance ECU 100 of the modification may be a special purpose computer configured to include at least one of a digital circuit and an analog circuit as a processor. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), and the like. Such a digital circuit may include a memory in which a program is stored.

The travel assistance ECU 100 may be provided by a set of computer resources linked by a computer or a data communication device. For example, a part of the functions provided by the travel assistance ECU 100 in the above-described embodiments may be realized by another ECU.

What is claimed is:

1. A driving support device configured to assist a lane change of a subject vehicle that cuts in a line of other vehicles traveling in a destination lane, the driving support device comprising:
a prediction unit configured to
predict an increase degree of an inter-vehicle distance between the other vehicles in response to the cut-in of the subject vehicle, and
determine whether the lane change is permissible based on the increase degree;
a trajectory determination unit configured to
determine, as a traveling trajectory of the subject vehicle, a lane change trajectory along which the subject vehicle changes lanes when it is determined that the lane change is permissible, and
determine, as the traveling trajectory of the subject vehicle, a cancel trajectory along which the subject vehicle cancels the lane change when it is determined that the lane change is not permissible; and
a necessity determination unit configured to determine whether a necessity level of the lane change is within an acceptable range, wherein
the prediction unit is configured to
cancel the determination whether the lane change is permissible based on the increase degree when it is determined that the necessity level is within the acceptable range, and
determine whether the lane change is permissible based on a linear prediction of a behavior of the other vehicles.

2. The driving support device according to claim 1, wherein
the prediction unit is configured to predict the increase degree based on a spring model in which the other vehicles are mass points.

3. The driving support device according to claim 1, wherein
the prediction unit is configured to
estimate a deceleration of one of the other vehicles, which is to be a following vehicle of the subject vehicle after the lane change, in response to the cut-in of the subject vehicle, and
predict the increase degree based on the estimated deceleration.

4. The driving support device according to claim 3, wherein
the prediction unit is configured to estimate the deceleration based on behavior characteristics of the one of the other vehicles in response to a change in the inter-vehicle distance.

5. The driving support device according to claim 1, wherein
the prediction unit is configured to determine, based on the increase degree, a start timing of the lane change after the subject vehicle reaches a front of one of the other vehicles which is to be a following vehicle of the subject vehicle after the lane change.

6. A method for a processor to assist a lane change of a subject vehicle that cuts in a line of other vehicles traveling in a destination lane, the method comprising:
predicting an increase degree of an inter-vehicle distance between the other vehicles in response to the cut-in of the subject vehicle;
determining whether the lane change is permissible based on the increase degree;
determining, as a traveling trajectory of the subject vehicle, a lane change trajectory along which the subject vehicle changes lanes when it is determined that the lane change is permissible;
determining, as the traveling trajectory of the subject vehicle, a cancel trajectory along which the subject vehicle cancels the lane change when it is determined that the lane change is not permissible; and
determining whether a necessity level of the lane change is within an acceptable range, wherein
the determination whether the lane change is permissible based on the increase degree is canceled and it is determined whether the lane change is permissible based on a linear prediction of a behavior of the other vehicles when it is determined that the necessity level is within the acceptable range.

7. The method according to claim 6, wherein
in the predicting the increase degree, the increase degree is predicted based on a spring model in which the other vehicles are mass points.

8. The method according to claim 6, wherein
in the predicting the increase degree, a deceleration of one of the other vehicles, which is to be a following vehicle of the subject vehicle after the lane change, in response to the cut-in of the subject vehicle is estimated, and the increase degree is predicted based on the estimated deceleration.

9. The method according to claim 8, wherein
in the predicting the increase degree, the deceleration is estimated based on behavior characteristics of the one of the other vehicles in response to a change in the inter-vehicle distance.

10. The method according to claim 6, wherein
in the predicting the increase degree, a start timing of the lane change after the subject vehicle reaches a front of one of the other vehicles which is to be a following vehicle of the subject vehicle after the lane change is determined based on the increase degree.

11. A computer program product for assisting a lane change of a subject vehicle that cuts in a line of other vehicles traveling in a destination lane, the computer program product being stored on at least one non-transitory computer readable medium and comprising instruction configured to, when executed by at least one processor, cause the at least one processor to:
predict an increase degree of an inter-vehicle distance between the other vehicles in response to the cut-in of the subject vehicle;
determine whether the lane change is permissible based on the increase degree;
determine, as a traveling trajectory of the subject vehicle, a lane change trajectory along which the subject vehicle changes lanes when it is determined that the lane change is permissible;
determine, as the traveling trajectory of the subject vehicle, a cancel trajectory along which the subject vehicle cancels the lane change when it is determined that the lane change is not permissible;
determine whether a necessity level of the lane change is within an acceptable range; and
cancel the determination whether the lane change is permissible based on the increase degree and determine whether the lane change is permissible based on a linear prediction of a behavior of the other vehicles when it is determined that the necessity level is within the acceptable range.

12. The computer program product according to claim 11, further comprising:
predict the increase degree based on a spring model in which the other vehicles are mass points.

13. The computer program product according to claim 11, further comprising:
estimate a deceleration of one of the other vehicles, which is to be a following vehicle of the subject vehicle after the lane change, in response to the cut-in of the subject vehicle; and
predict the increase degree based on the estimated deceleration.

14. The computer program product according to claim 13, further comprising:
estimate the deceleration based on behavior characteristics of the one of the other vehicles in response to a change in the inter-vehicle distance.

15. The computer program product according to claim 11, further comprising:
determine, based on the increase degree, a start timing of the lane change after the subject vehicle reaches a front of one of the other vehicles which is to be a following vehicle of the subject vehicle after the lane change.
